(19) United States
(12) Patent Application Publication
(10) Pub. No.: US 2013/0327224 A1
(43) Pub. Date: Dec. 12, 2013

(54) COOKING SYSTEM CAPABLE OF AUTOMATED STIRRING AND MIXING OF FOOD INGREDIENTS

(71) Applicant: Zhengxu He, Reno, NV (US)

(72) Inventor: Zhengxu He, Reno, NV (US)

(21) Appl. No.: 13/490,523

(22) Filed: Jun. 7, 2012

(51) Int. Cl. A47J 27/00

(52) U.S. Cl. 99/348

(57) ABSTRACT

The present application discloses an automated cooking apparatus that include a cooking pan comprising an internal surface and one or more barriers constructed on or near the internal surface. The cooking pan can hold food ingredients for cooking. A transport mechanism can move the cooking pan to produce movements in the food ingredients. The one or more barriers can obstruct the food ingredients' movements to produce stirring and mixing in the food ingredients.

### BACKGROUND OF THE INVENTION

The present application relates to automated kitchen equipment, and specifically to automated method and equipment for stirring and mixing food ingredients during cooking.

Considerable amount of research and experiments have been conducted on the automation of stirring and mixing of food ingredients during cooking. The existing solutions include the following three main approaches: the first approach is to simulate human's stirring actions during cooking; the second approach utilizes pedals of different shapes to stir and mix food ingredients; and the third approach uses rolling cylinders to stir and mix food ingredients.

The first approach involves complex operations and complicated mechanisms, and thus has low reliability. Specifically, the stirring wok mechanism disclosed in Chinese Application No. 200710032699.9 teaches throwing food ingredients in the air for mixing. Such an approach is easily affected by air movement and sometimes throws food ingredients outside of the wok. In addition to the structural complexity, the stirring operations involve large movements, which use too much energy.

The second approach includes simpler operations and practical mechanisms, but is ineffective in mixing and stirring food ingredients. This approach cannot achieve the uniform stirring and mixing obtained by a human. One major reason for such poor result is that the movements of the spatula can only perform simple rotating movements and cannot mix food ingredients in irregular movements. In an attempt to overcome this drawback, Chinese Application No. 200610081415.1 discloses an automatically stirring wok including rotation of the stirring spatula. The disclosed mechanism is rather complex and often breaks food ingredients.

The third approach utilizes rolling cylinders and sometime with separators on the internal surface of the cylinder (similar to a front load cloth dryer). When the cylinder is rotated, the food ingredients are brought up, and then fall freely pulled down by gravity, which stirs and mixes the food ingredients. This approach is simple and mechanism reliable, but it requires a large amount of cooking oil to coat the whole surface of the cylinder to prevent food sticking to and burning at the internal surfaces. Moreover, such mechanism is also not effective in heating the food ingredients. Lots of energy is dissipated in the rotation of the cylinder. Specifically, Chinese Application No. 200720019984.3 teaches a rotating-cylinder based cook device. The axis of the cylinder is positioned horizontally. The device has a very poor heating efficiency for cooking, and is extremely energy inefficient.

There is therefore a need for an effective and efficient automated food device for stirring and mixing food ingredients during cooking.

### SUMMARY OF THE INVENTION

The present application discloses a cooking apparatus capable of automated stirring and mixing of food ingredients, which overcomes the drawbacks in the conventional cooking devices. The disclosed automated cooking apparatus is more effective in stirring and mixing feed ingredients, and is more energy efficient. The stirring mechanisms and operations of the disclosed automated cooking apparatus are simpler and more reliable. The disclosed automated cooking apparatus can achieve more effective and uniform stirring and mixing during cooking. Moreover, the disclosed automated cooking apparatus is more energy efficient compared to the conventional automated cooking devices.

In one general aspect, the present invention relates to an automated cooking apparatus, that includes a cooking pan comprising an internal surface and one or more barriers constructed on or near the internal surface, wherein the cooking pan can hold food ingredients for cooking; and a transport mechanism that can move the cooking pan to produce movements in the food ingredients, wherein the one or more barriers are configured to obstruct the food ingredients' movements to produce stirring and mixing in the food ingredients.

Implementations of the system may include one or more of the following. The transport mechanism can produce a circular movement in the cooking pan while preserving the orientation of the cooking pan. The transport mechanism can include two or more shafts that are configured to be rotated synchronously to produce a circular movement in the cooking pan. The transport mechanism can allow a radius of the circular movement to be adjusted according to types of food ingredients and styles of the cooking. The transport mechanism can rotate the cooking pan. The transport mechanism can move the cooking pan along a spherical surface. The one or more barriers can have a cross-shape, a star-shape, a ring-shape, or a spiral-shape. The one or more barriers can be constructed on the internal surface of the cooking pan. The one or more barriers can be constructed above and near the internal surface of the cooking pan, wherein the distance of the one or more barriers from the internal surface of the cooking pan is adjustable. The one or more barriers can include rugged or textured surface structure on the internal surface of the cooking pan. The one or more barriers can have the shape of a ridge, a wall, or a bump. The one or more barriers can cause the food ingredients to turn, tumble, jump, flip and/or to be thrown in the air by obstructing to movements of the food ingredients. The transport mechanism can move the cooking pan in one or more linear directions. The transport mechanism can move the cooking pan in two intercepting linear directions. The transport mechanism can produce accelerations, vibrations, rotations, and/or translations in the food ingredients in the cooking pan.

In another aspect, the present invention relates to an automated cooking apparatus that includes a cooking pan configured to hold food ingredients for cooking, wherein the cooking pan includes an internal surface having a surface structure; and a transport mechanism that can move the cooking pan to produce movements in the food ingredients. The surface structure can obstruct the food ingredients' movements to produce stirring and mixing in the food ingredients.

Implementations of the system may include one or more of the following. The surface structure can include one or more barriers constructed on or near the internal surface. The surface structure can include a ridge, a wall, a bump, or a rugged or textured surface.

These and other aspects, their implementations and other features are described in detail in the drawings, the description and the claims.

### BRIEF DESCRIPTION OF THE DRAWINGS

FIG. 1 illustrates a rectangular cooking pan having cross-shaped barriers on the internal surface of the container suitable for the presently disclosed cooking apparatus.

FIG. 2 illustrates a cooking pan having star-shaped barriers on the internal surface of the container suitable for the presently disclosed cooking apparatus.

FIGS. 3 and 4 are respectively perspective and cross-sectional views of a cooking pan having a ring-shaped barrier on the internal surface of the container suitable for the presently disclosed cooking apparatus.

FIG. 5 illustrates a cooking pan having a suspended ring-shaped barrier near the bottom of the cooking pan suitable for the presently disclosed cooking apparatus.

FIGS. 6A and 6B are respectively perspective and cross-sectional views of a cooking pan having cross-shaped barriers on the internal surface of the container suitable for the presently disclosed cooking apparatus.

FIG. 7 illustrates a cooking pan having star-shaped barriers on the internal surface of the container suitable for the presently disclosed cooking apparatus.

FIGS. 8A-8C illustrates a cooking pan having spiral-star shaped barriers on the internal surface of the container suitable for the presently disclosed cooking apparatus.

FIGS. 9A-9B are respectively perspective and top views a cooking pan having spiral-shaped barriers on the internal surface of the container suitable for the presently disclosed cooking apparatus. FIG. 9C is a cut-out view of the cooking pan along A-A in FIG. 9B.

FIGS. 10A-10B respectively show top and side views of an automated cooking apparatus that can produce x-y linear movements in a cooking pan.

FIGS. 11A-11B respectively show top and side views of an automated cooking apparatus that can produce circular movements in a cooking pan.

FIGS. 12A-12B respectively show top and side views of an automated cooking apparatus that can produce circular movements in a cooking pan.

FIGS. 13A-13B respectively show top and side views of an automated cooking apparatus that can produce circular movements in a cooking pan in a constrained angular range.

FIGS. 14A-14B respectively show top and side views of another automated cooking apparatus that can produce circular movements in a cooking pan, wherein the “radius” of the circular movement can be controlled.

FIG. 14C is a detailed perspective view of the apparatus that can be added to control the distance between the center shaft and the eccentric shaft.

FIGS. 15A-15B respectively show top and side views of another automated cooking apparatus that can produce circular movements and rotations in a cooking pan.

FIG. 16A-16C each shows a cooking apparatus in which a cooking pan is moved by a transport mechanism on a spherical surface.

FIG. 17 is a detailed perspective view of the cooking apparatus shown in FIGS. 13A-13B.

FIG. 18 is a detailed perspective view of an implementation the rotation mechanism of the cooking apparatus shown in FIG. 17.

FIG. 19 is a detailed perspective view of the shaker plate.

FIG. 20 is a detailed perspective view of the support frame.

### DETAILED DESCRIPTION OF THE INVENTION

The present application discloses a cooking apparatus that provides automated stirring and mixing of food ingredients, while overcoming the drawbacks in the conventional cooking devices. The disclosed cooking apparatus includes a cooking pan that includes barriers for the movements of food ingredients, and a mechanism that can support and move the cooking pan.

During cooking, the cooking pan is driven by a transport mechanism to conduct pre-designed movements (linear, cyclic, circular, semi-circular, spherical, irregular, etc.). The food ingredients contained in the cooking pan is accelerated with the cooking pan. The barriers in the cooking pan play the role of spatula in traditional cooking: the barriers can stir, turn, flip, mix, and aerate the food ingredients by inhibiting their movements. The movements of the cooking pan can be frequent and have small amplitudes to replace the relatively less frequent and large amplitude manual stirring in traditional cooking.

In one aspect, the disclosed cooking apparatus does not directly mimic the motions of the spatula in traditional cooking, like some conventional automated cooking devices. Instead, the disclosed cooking apparatus is designed to realize the advantages of automated mechanical systems to achieve better mixing and more uniform cooking of the food ingredients than manual cooking.

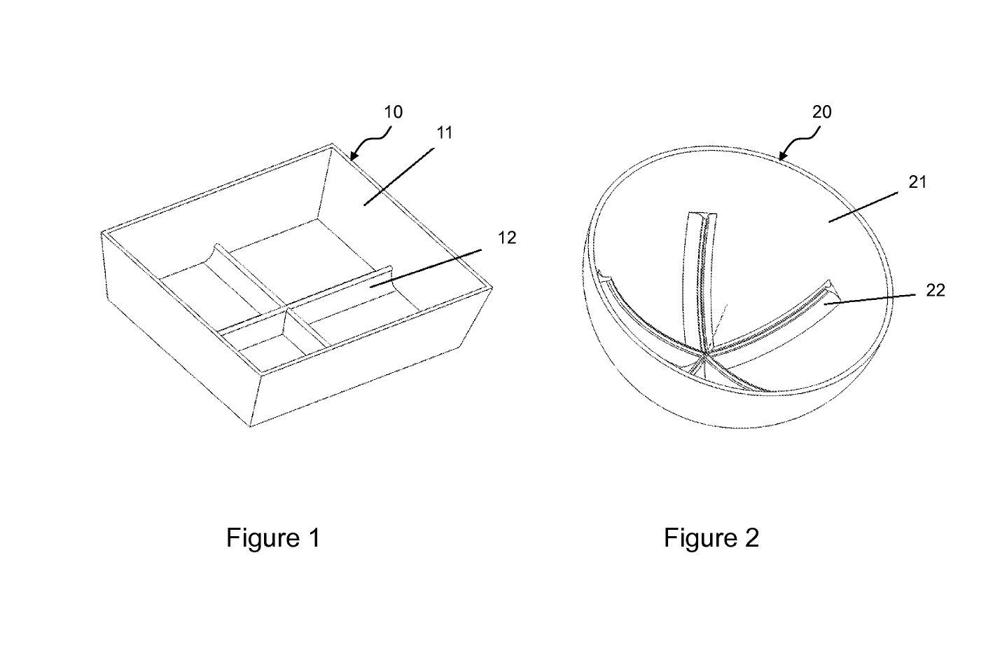

Referring to FIGS. 1-9C, the barriers are constructed on the internal surfaces of cooking pans. The barriers can have different shapes and dimensions, and constructed at different positions in the container.

In one example, as shown in FIG. 1, a cooking pan 10 includes a rectangular container 11 and cross-shaped barriers 12 on the internal surface at the bottom of the container 11.

In another example, as shown in FIG. 2, a cooking pan 20 includes star-shaped barriers 22 on the internal surface at the bottom of a round container 21.

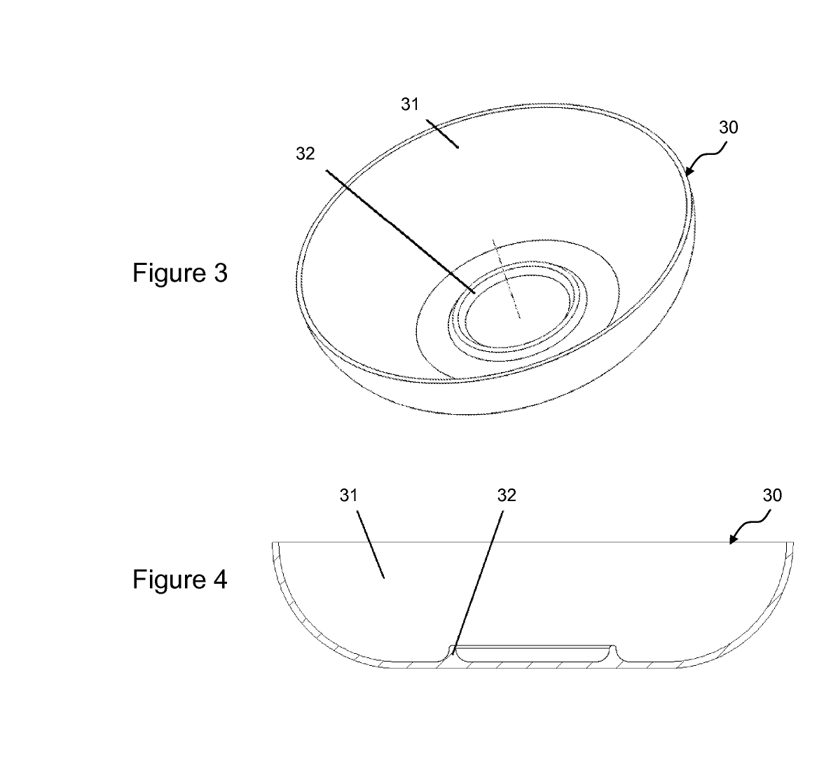

In another example, as shown in FIG. 3 or 4, a cooking pan 30 has a ring-shaped barrier 32 at the bottom of a round container 31.

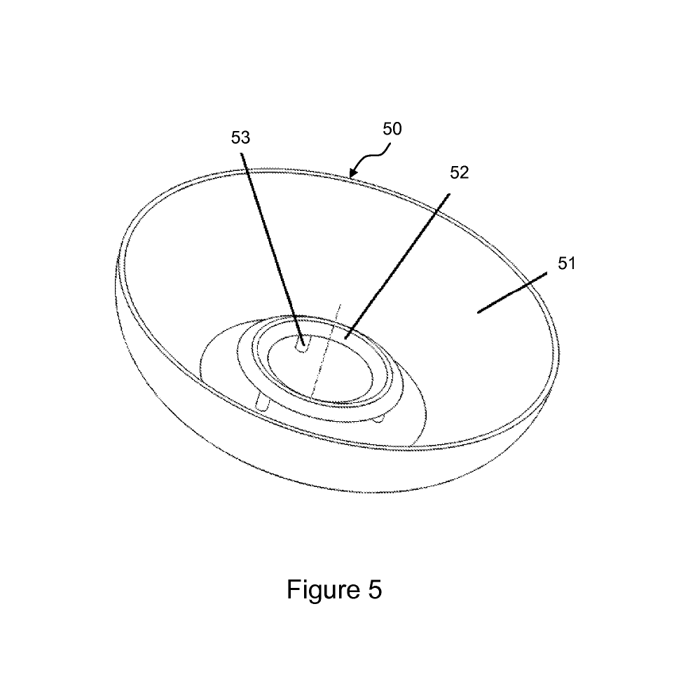

In another example, as shown in FIG. 5, a cooking pan 50 has a ring-shaped barrier 52 supported by footings 53 at the bottom of a container 51.

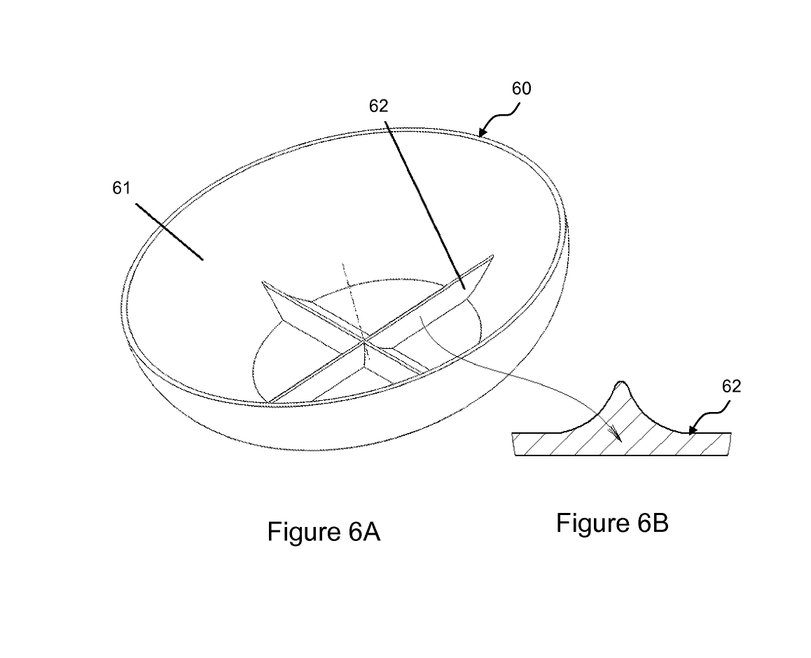

In another example, as shown in FIGS. 6A and 6B, a cooking pan 60 has cross-shaped barriers 62 at the bottom of a round container 61.

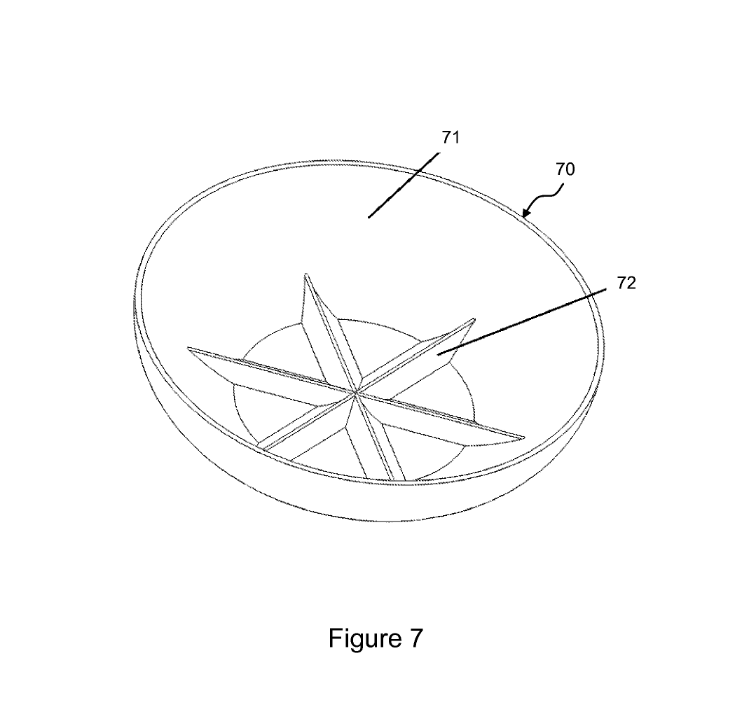

In another example, as shown in FIG. 7, a cooking pan 70 has a star-shaped barrier 72 at the bottom of a container 71.

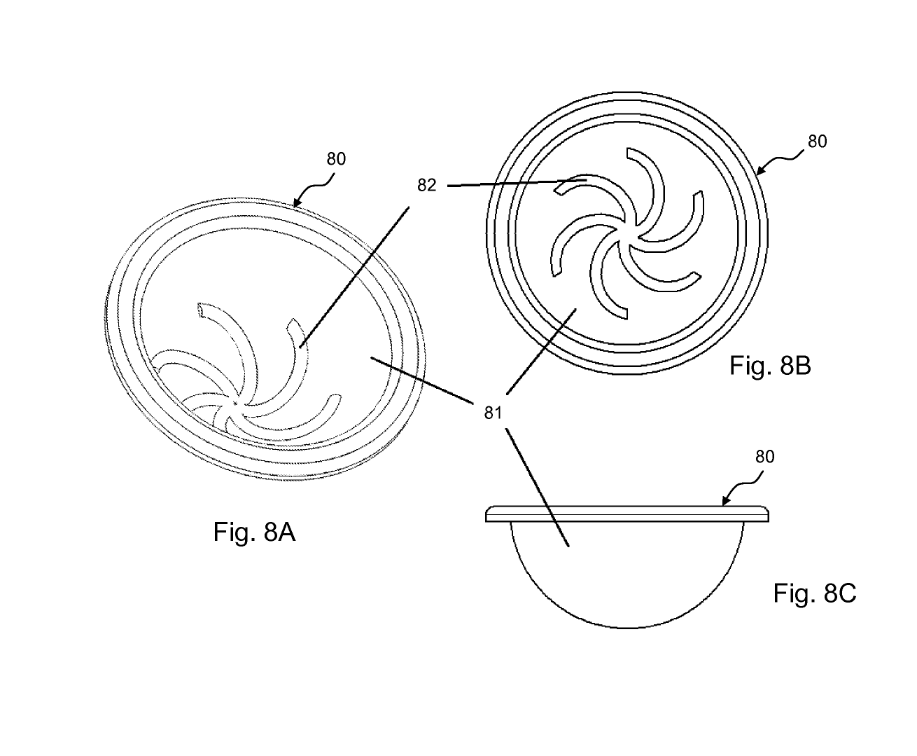

In another example, as shown in FIGS. 8A-8C, a cooking pan 80 has spiral-star shaped barriers 82 at the bottom of a round container 81.

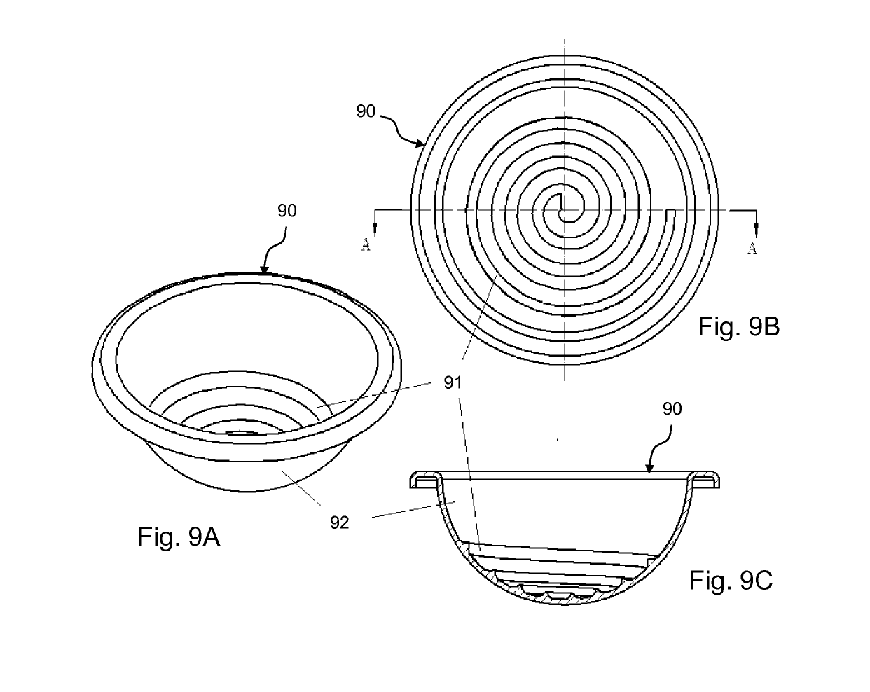

In another example, as shown in FIGS. 9A-9C, a cooking pan 90 has spiral-shaped barriers 92 at the bottom of a round container 91.

It should be noted that the barriers can have different shapes, dimensions, and located at different positions of the cooking pan from the examples given above. For example, barriers can have dotted or interrupted ridges or walls or bumps, in addition to or in combination with continuous ridges or walls or bumps. The barriers can be symmetric or non-symmetric, and vary their shapes (e.g. wavy shape) along the long dimensions of the barriers. The barriers may also be attached to an inner surface of the wall as well as the bottom of the cooking pan. The cooking pan can have rugged or textured surface structures on the internal surface.

Moreover, the barriers can be made as unitary components of the cooking pan by molding or pressing. The barriers can also be fabricated separately and attached to the inner surface of the cooking pan.

Furthermore, the cooking pan can have different shapes such as round, oval, rectangular, square, etc. The cooking pan can have curved or flat bottoms.

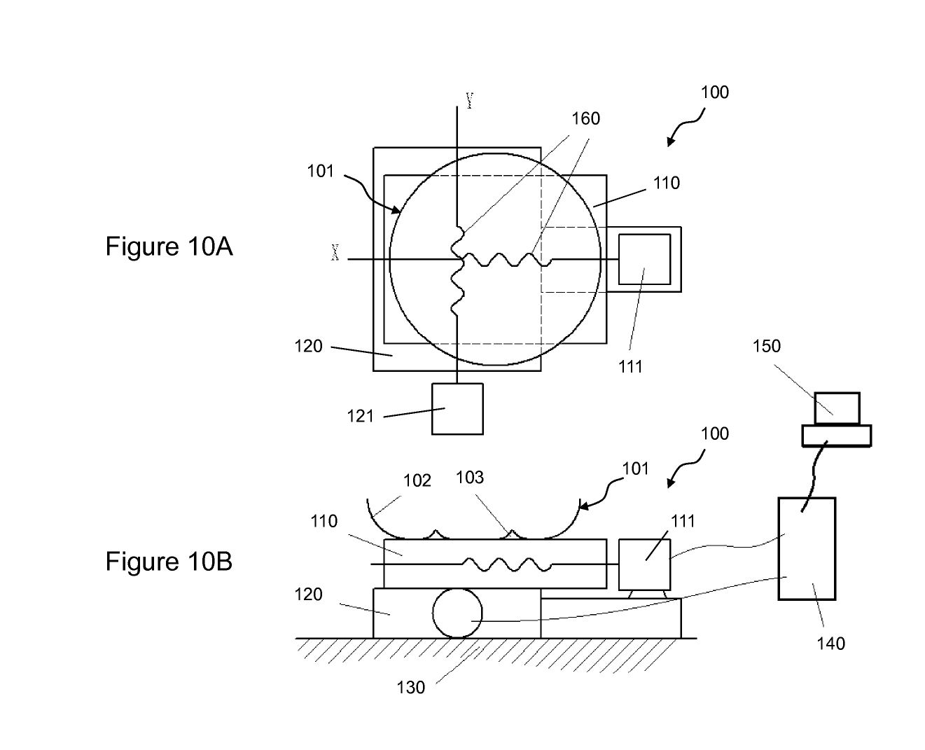

In some embodiments, referring to FIGS. 10A and 10B, an automated cooking apparatus 100 includes a cooking pan 101, an upper frame 110, and a lower frame 120 placed on a platform 130. The cooking pan 101 comprises a container 102 and barriers 103. The cooking pan 101 is fixedly placed on the upper frame 110. A motor 111 is fixed on the lower frame 120 along the X-axis direction. The upper frame 110 can be moved by the motor 111 relative to the lower frame 120. The lower frame 120 can be moved by a motor 121 along the Y-axis direction. The cooking pan 101 can thus be moved by motors 111, 121 along linear or curved path in the X-Y plane. The motors 111, 121 can be controlled by a controller 140 according a program stored in a computer 150 to obtain optimal mixing and stirring of food ingredients during cooking Rotations of the motors 111, 121 can be transformed to translational motions of the cooking pan 101 and the upper frame 110 by, for example, by a helical-screw mechanism 160 (as shown in FIG. 10A, 10B) or a crank-and-slider mechanism.

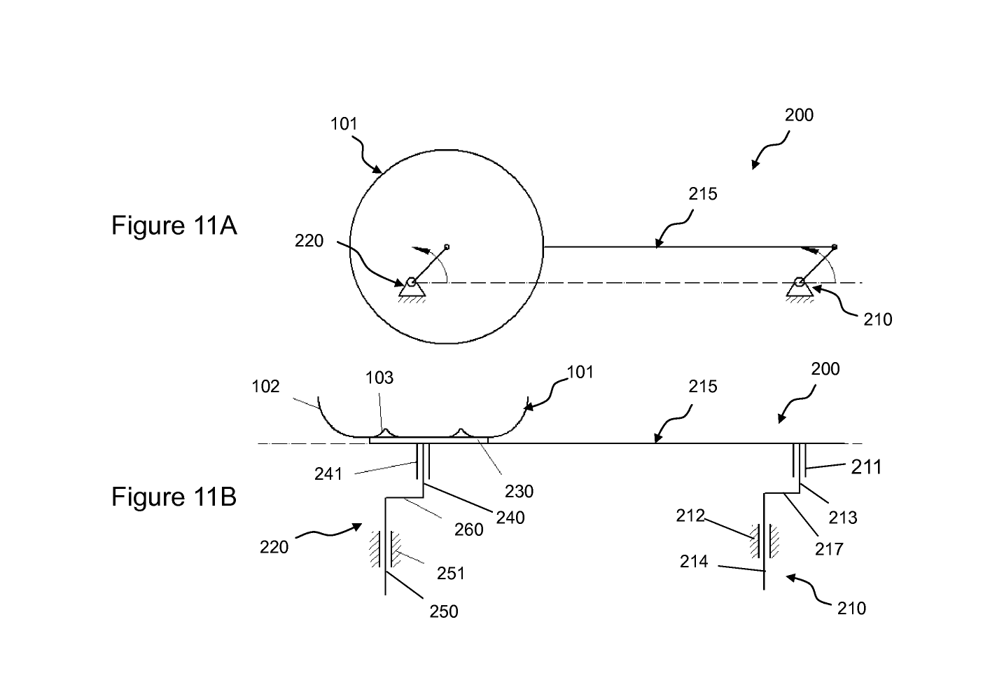

In some embodiments, referring to FIGS. 11A and 11B, an automated cooking apparatus 200 includes a cooking pan 101, a first mechanism 210, a second mechanism 220, and a shaker plate 230 which carries the cooking pan 101. The first mechanism 210 includes a center shaft 214 in a sleeve 212, and an eccentric shaft 213 in a sleeve 211. The shafts 214 and 213 are connected with connector 217. The second mechanism 220 includes a center shaft 250 in a sleeve 251, an eccentric shaft 240 in a sleeve 241 fixedly connected to the shaker plate 230, and a connector 260 that fixedly connects the center shaft 250 and the eccentric shaft 240. The first mechanism 210 allows rotational movement around the center shaft 214. The second mechanism 220 allows circular movement of the shaker plate 230 and the cooking pan 101 around the center shaft 250. A crank connector 215 fixedly connects the shaker plate 230 to the sleeve 211, which enable the eccentric shaft 213 and the eccentric shaft 240 to rotate synchronously respectively around the center shaft 214 and the center shaft 250. One of the first mechanism 210 and the second mechanism 220 can be the driver while the other being a follower. The cooking pan 101 is fixedly held to the shaker plate 230 to prevent rotation around the eccentric shaft 240. In other words, the orientation of the cooking pan 101 is maintained during the circular movements around the center shafts 214, 250. The first mechanism 210 and the second mechanism 220 can be implemented by clamping bearing mechanism. The support to the shaker plate 230 and the sleeve 211 by two eccentric shafts 213 and 240 can lower the impact and noise created by the movements of the cooking pan 101. Furthermore, the disclosed automated cooking apparatus 200 is compatible with transport mechanisms comprising three of more eccentric mechanisms like the first mechanism 210 and the second mechanism 220.

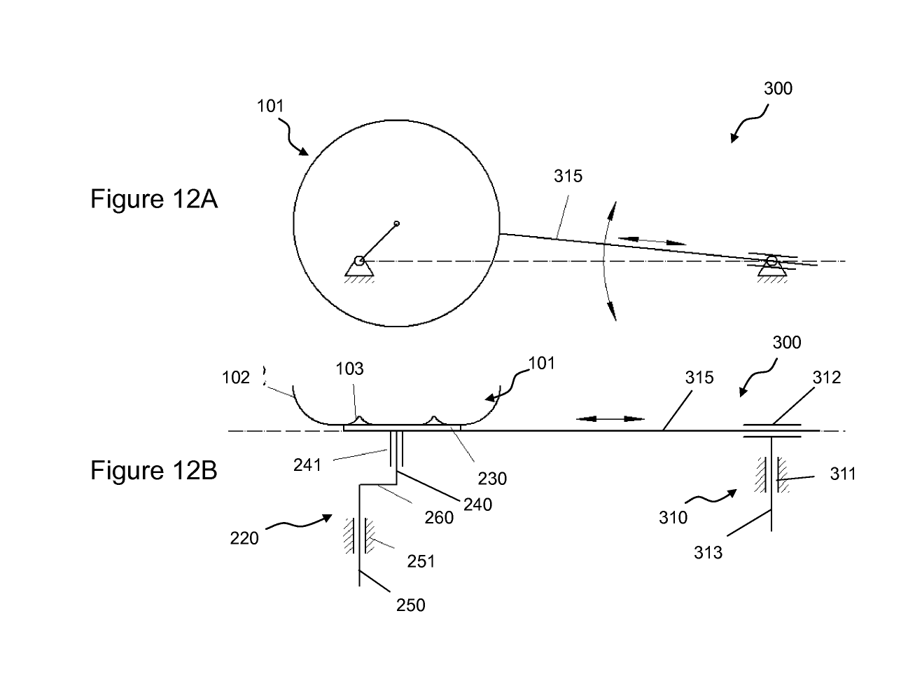

In some embodiments, referring to FIGS. 12A and 12B, an automated cooking apparatus 300 includes a cooking pan 101, a first mechanism 310, the second mechanism 220, and a shaker plate 230 which carries the cooking pan 101. The first mechanism 310 includes a center shaft 313 in a sleeve 311 and rotating sleeve 312. The second mechanism 220 can produce circular movements of the cooking pan 101 around the center shaft 250 in a sleeve 251. A crank rod 315 is fixedly connected to the shaker plate 230 and can slide through the rotating sleeve 312 along the section near the opposite end, which allows the circular movements of the cooking pan 101 around the center shaft 250. The first mechanism 310 can prevent free rotation of the cooking pan 101 around its center and also helps to stabilize the cooking pan 101 in the circular movements.

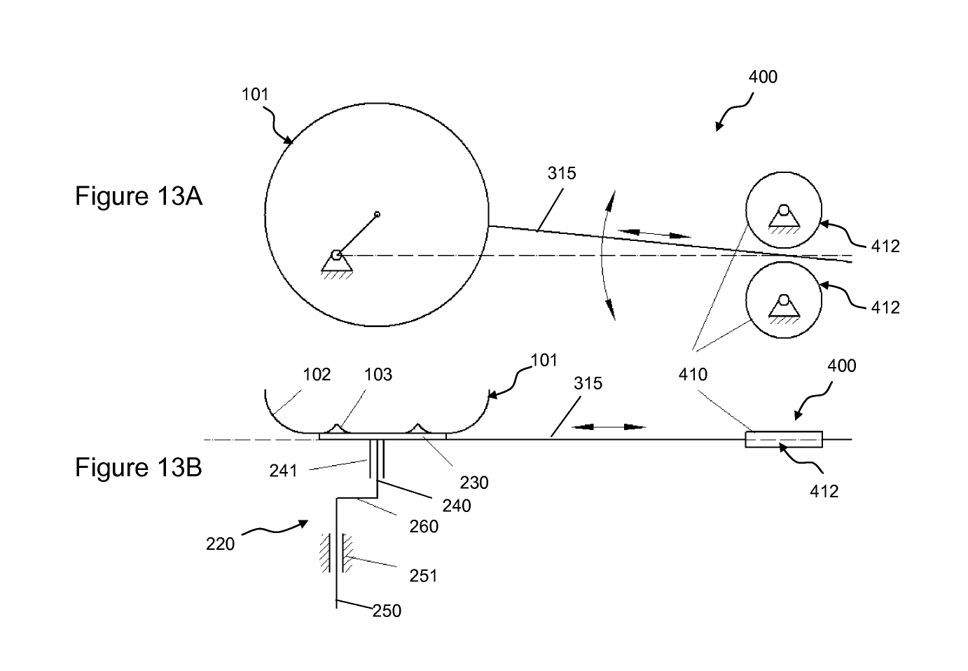

In some embodiments, referring to FIGS. 13A and 13B, an automated cooking apparatus 400 includes a cooking pan 101, a first mechanism 410, the second mechanism 220, and a shaker plate 230 which carries the cooking pan 101. The first mechanism 410 includes locating bearings 412. The second mechanism 220 can produce circular movements of the cooking pan 101 around the center shaft 250. A crank rod 315 is fixedly connected to the shaker plate 230 at one end and can slide through the rotatable locating bearings 412 along the section near the other end, which allows the rotation of the cooking pan 101 around the center shaft 250. The function of the first mechanism 410 is similar to those of the first mechanism 310 described above (FIGS. 12A and 12B).

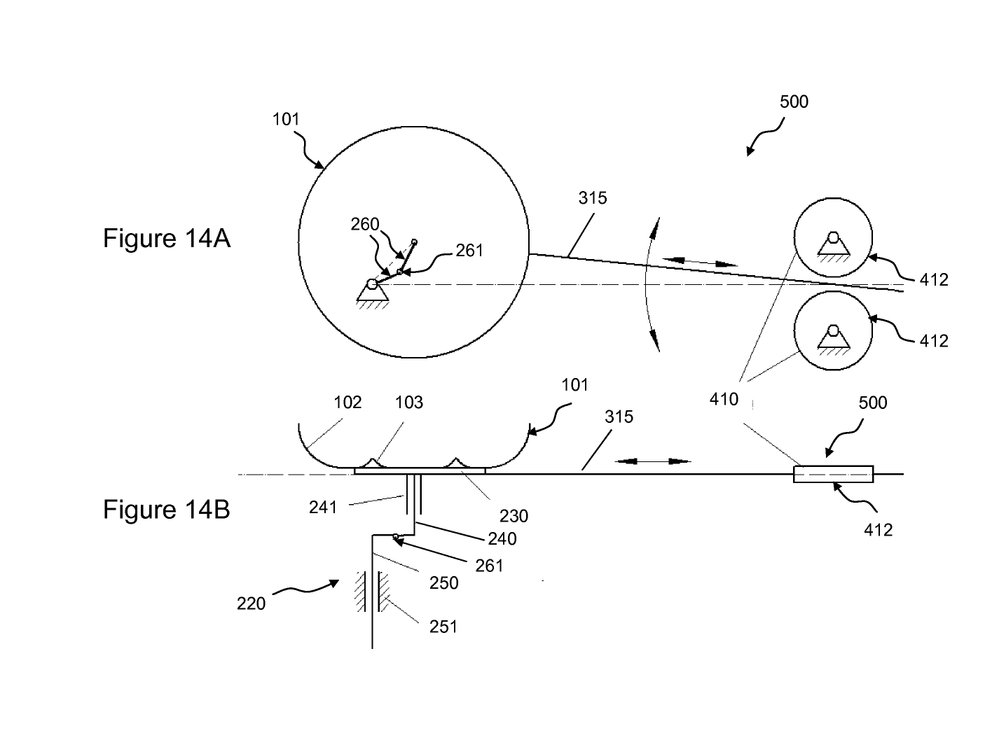

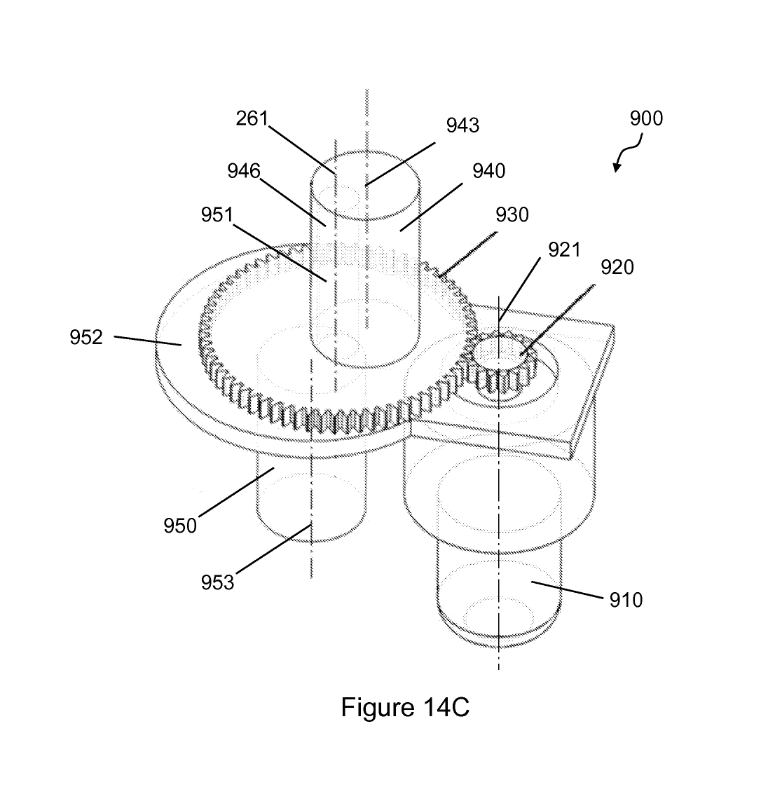

In some embodiments, referring to FIGS. 14A and 14B, an automated cooking apparatus 500 includes similar components as automated cooking apparatus 400 except for the second mechanism 220 first includes a joint 261 in the connector 260. The angle in the joint 261 can be changed by a controlled rotating motor, and thus the distance between the eccentric shaft 240 and the center shaft 250 can be controlled. That is, the “radius” of the circular movement can be controlled. An advantage of this design is that the “radius” of the circular movement of the cooking pan 101 can be varied based on the type of food ingredients being cooked and also based on time in the cooking process. A smaller radius of circular movement can be used for food ingredients that are easily broken so the shape and appearance of the food ingredients can be preserved during cooking. For food ingredients that are not easily broken, they can be more vigorously stirred, mixed, and aerated by selecting a high degree of eccentricity. Moreover, by reducing the “radius” to zero, it can bring the cooking pan 101 to a predetermined position no matter how many angular degrees the center shaft 250 has rotated.

In some embodiments, referring to FIG. 14C, the circular movements of the cooking pan described above can be automatically adjusted using a double eccentric mechanism 900. A first eccentric mechanism 950 includes a plate 952, a shaft 953 (corresponding to the center shaft 250 in FIGS. 14A, 14B), and a shaft 951. A second eccentric mechanism 940 includes a gear plate 930, a shaft 943 (corresponding to the center shaft 240 in FIGS. 14A, 14B), and a hole 946 that is through the center axis of the hear plate 930. The shaft 951 is inserted into the hole 946 to form the joint 261 (FIGS. 14A, 14B) described above. A motor 910 is mounted on the plate 952. The shaft of the motor 910 drives a gear 920 that is engaged with the gear plate 930, and thus produces a rotation of the gear plate around the joint 261. The distance between the shaft 953 (250 in FIGS. 14A, 14B) and the shaft 943 (240 in FIGS. 14A, 14B), that is the radius of the circular movements of the cooking pan, can thus be adjusted.

The double eccentric mechanism 900 in FIG. 14C, can also be added to the apparatus in FIGS. 11A, 11B, 12A, 12B, 13A, 13B to control the distance between the center shaft and the eccentric shaft; e.g., the distance between 214 and 213 and synchronously, the distance between 250 and 240 in FIG. 11B; or the distance between 250 and 240 in FIG. 12B; or the distance between 250 and 240 in FIG. 13B.

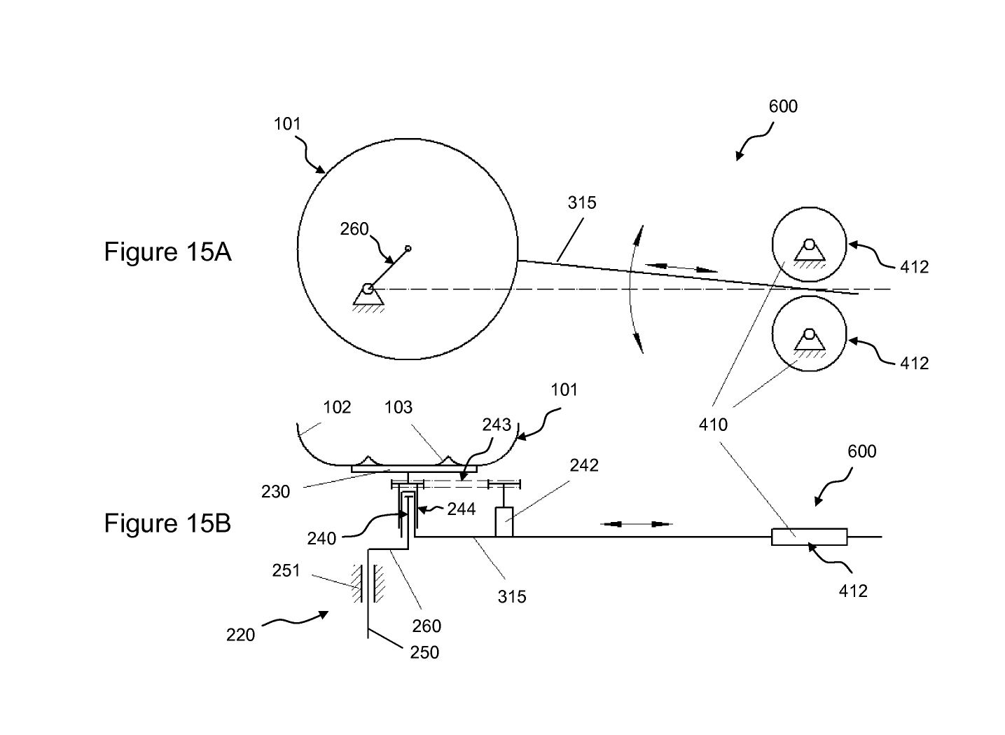

In some embodiments, referring to FIGS. 15A and 15B, an automated cooking apparatus 600 includes similar components as automated cooking apparatus 400. Additionally, the shaker plate 230 is fixedly connected to a socket 244. The eccentric shaft 240 is inserted in the socket 244 to allow the socket 244, the shaker plate 230, and the cooking pan 101 to rotate around the eccentric shaft 240. The rotation of the socket 244 is driven by a motor 242 via a belt 243. The eccentric shaft 240 can be aligned through the center of the container 102. As a result, the cooking pan 101 can be rotated around the eccentric shaft 240 as well as can be moved along a circular path around the center shaft 250.

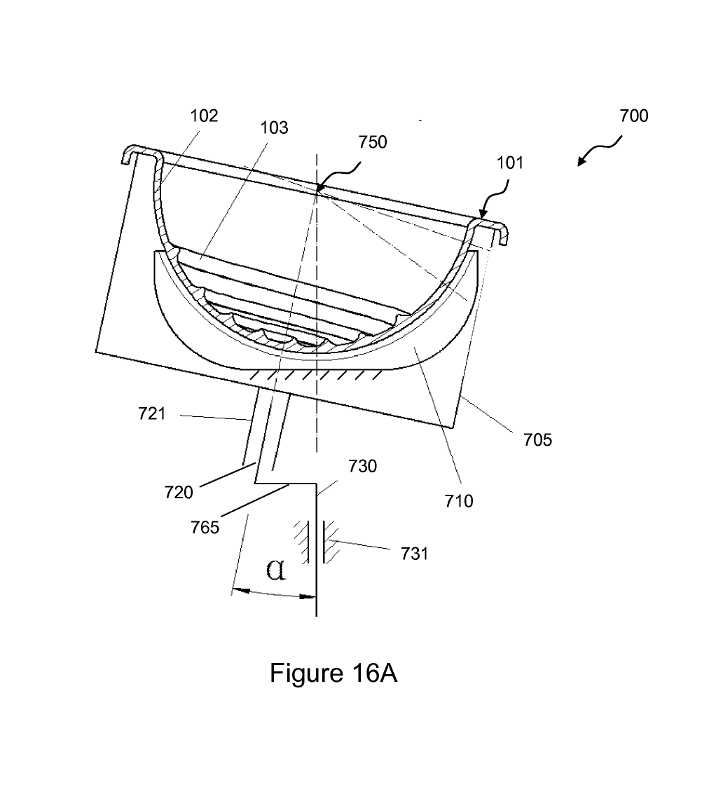

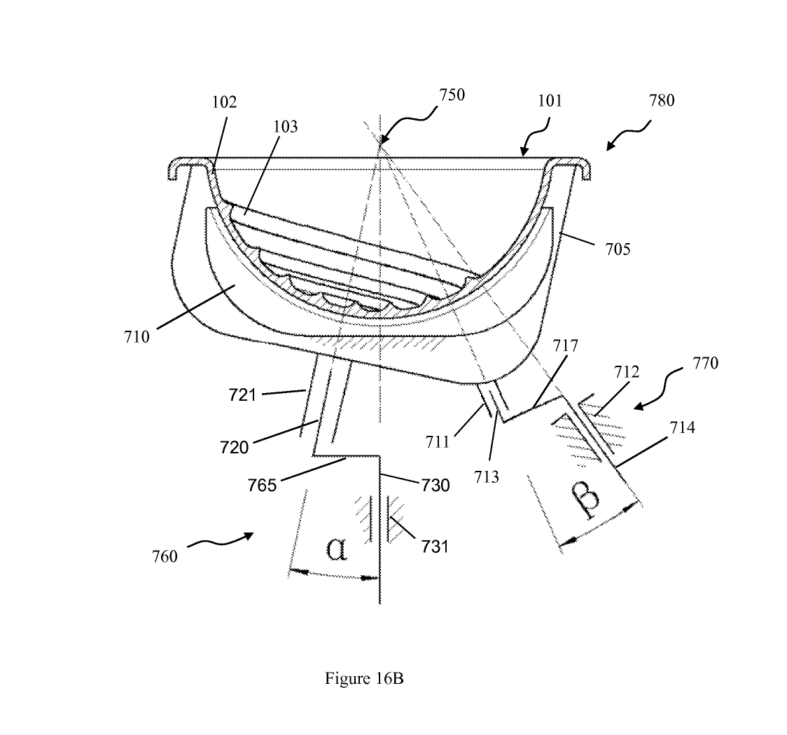

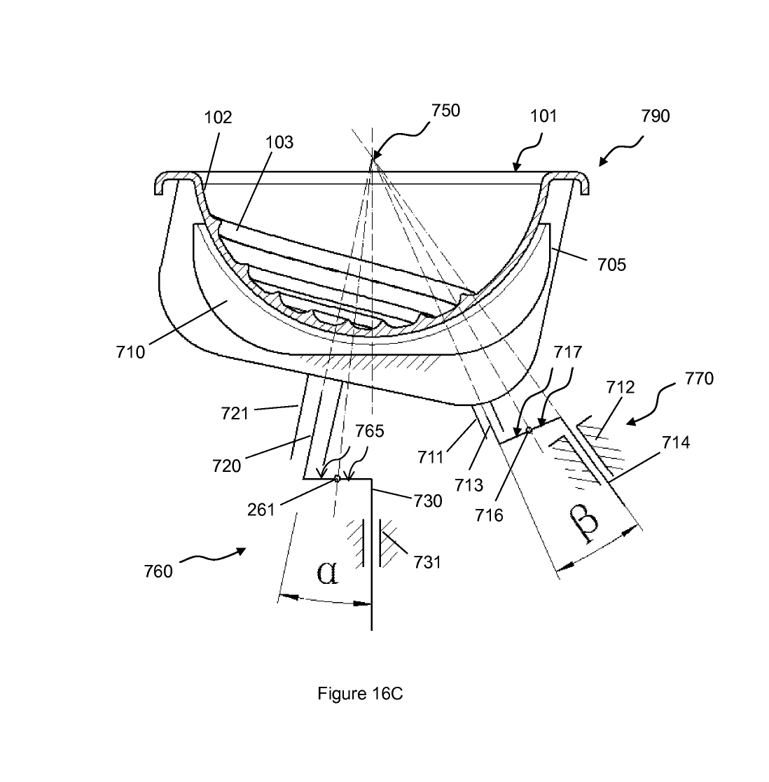

In some embodiments, FIG. 16A, shows a cooking apparatus 700 in which a cooking pan 101 can be moved by a transport mechanism on a spherical surface defined by a center 750. The cooking apparatus 700 includes a holder 705 and a heater 710. The cooking pan 101 is held in the holder 705. The holder 705 is connected to an eccentric shaft 720 in a sleeve 721 and a center shaft 730 in a sleeve 731. The eccentric shaft 720 and the center shaft 730 are connected by connector 765. The cooking pan 101 can have a substantially spherical outer surface. The eccentric shaft 721 and the center shaft 730 are respectively oriented along lines passing through the center 750 of the spherical surface of the cooking pan 101.

In FIG. 16B, an automated cooking apparatus 780 includes a cooking pan 101, a first mechanism 760, a second mechanism 770, a holder 705 which carries the cooking pan 101, and a heater 710. The first mechanism 760 includes a center shaft 730 in a sleeve 731 and an eccentric shaft 720 in a sleeve 721 fixedly connected to the holder 705. Shaft 730 and shaft 720 are connected with connector 765. The second mechanism 770 includes a center shaft 714 in a sleeve 712, an eccentric shaft 713 in a sleeve 711 fixedly connected to the holder 705. Shafts 714 and 713 are connected with connector 717. The first mechanism 760 allows circular movement of the holder 705 and the cooking pan 101 around the center shaft 730. The second mechanism 770 allows circular movement of the holder 705 and the cooking pan 101 around the center shaft 714. The angle α between the center shaft 730 and the eccentric shaft 720 must not exceed the angle between the center shaft 714 and eccentric shaft 713. If a equals to β, then both center shafts 730 and 714 may rotate continuously in one direction or in mutually opposite directions. If α is strictly less than β, then the center shaft 730 can rotate continuously in one direction but the center shaft 714 have to rotate back and forth. In this case, the shaft 714 can limit the movement of the cooking pan, including the pan's self-rotation. Thus the shaft 714 should not usually be rotated by a motor (except in a carefully calculated synchronous movement).

FIG. 16C shows an automated cooking apparatus 790, which is similar to double eccentric mechanism 780 in FIG. 16B. The angle α between the center shaft 730 and the eccentric shaft 720 can be controlled by adjusting the joint angle of the connector 765 at the joint 261. Similarly, the angle between the center shaft 714 and eccentric shaft 713 can be adjusted by adjusting the joint angle of the connector 717 at the joint 716. The axes 730, 720, 261 in FIG. 16C pass through the center 750. Similarly, the axes of the shafts 714, 713 and 716 also pass through the center 750.

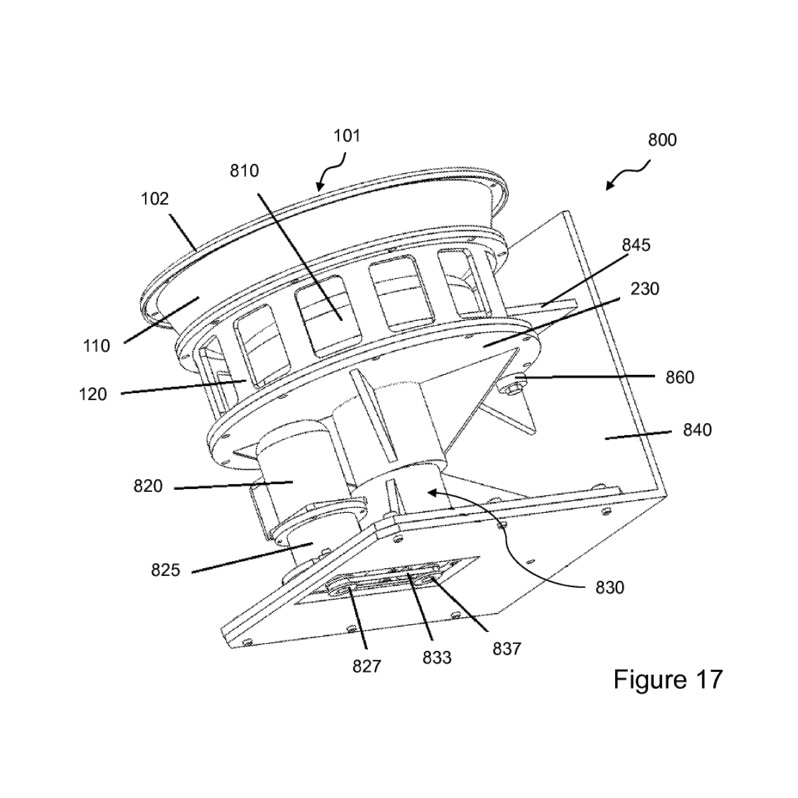

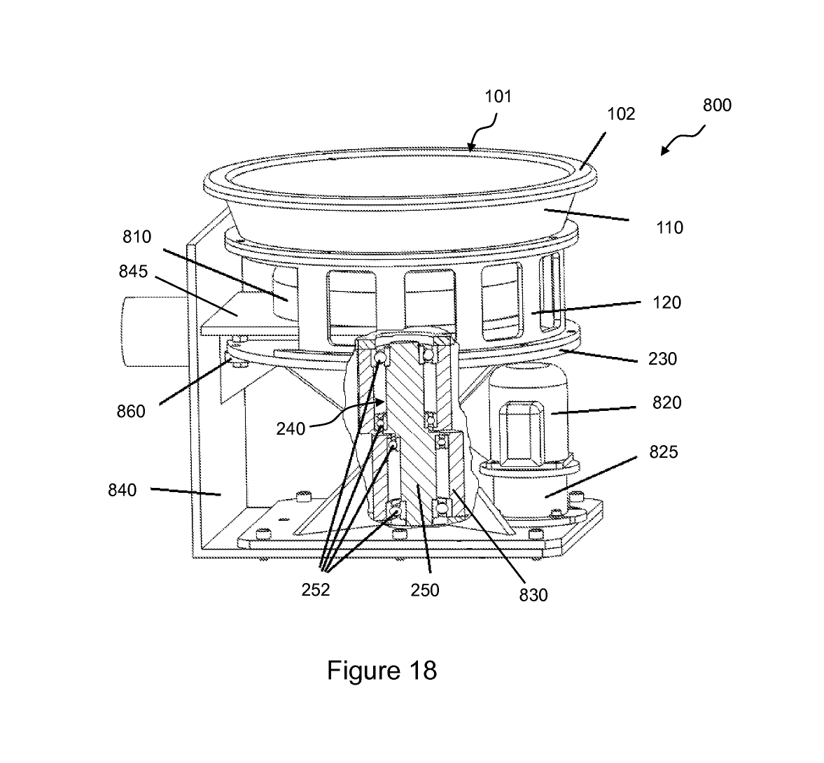

In some embodiments, referring to FIGS. 17 and 18, a cooking apparatus 800 includes an upper frame 110 holding a cooking pan 101, and a lower frame 120 holding the upper frame 110. A motor 820 is mounted on a base 825 which is mounted on a base 830. The base 830 is fixedly mounted on a frame 840. A heater 810 is mounted on an overhanging plate 845 fixed to the frame 840 for heating food ingredients in the cooking pan 101 during cooking.

The motor 820 can turn a belt wheel 827. The eccentric shaft 240 and the center shaft 250 are mounted between four sets of bearings 252. The top portion of bearings 252 are assembled to the sleeve of shaker plate 230. The lower portion of bearings 252 are assembled to the sleeve of the base 830. The belt wheel 827 and the belt wheel 837 are connected via a belt 833 by friction. Thus the motor 820 can drive the center shaft 250 to create circular movements in the shaker plate 230 and the cooking pan 101 around the center shaft 250.

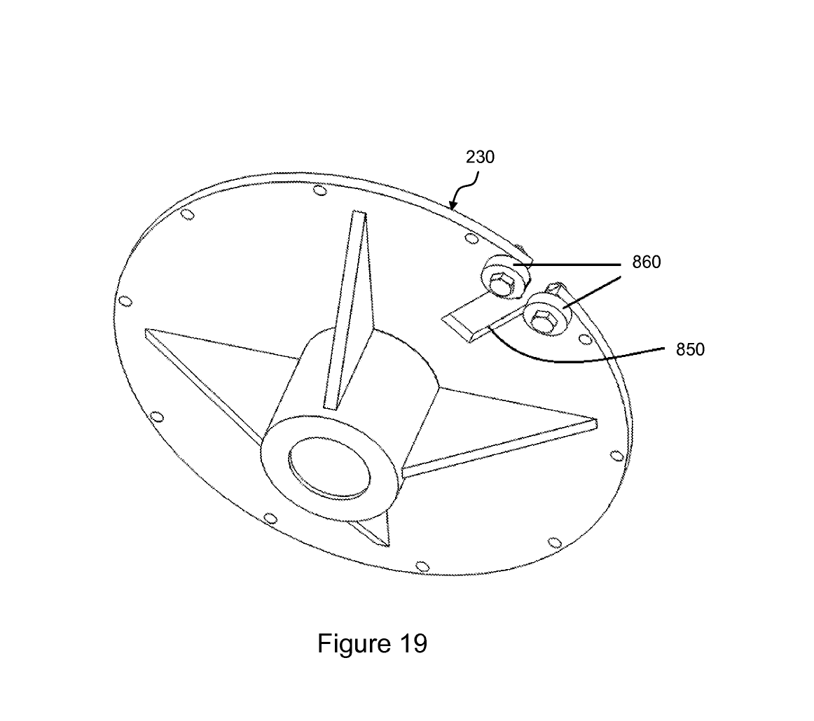

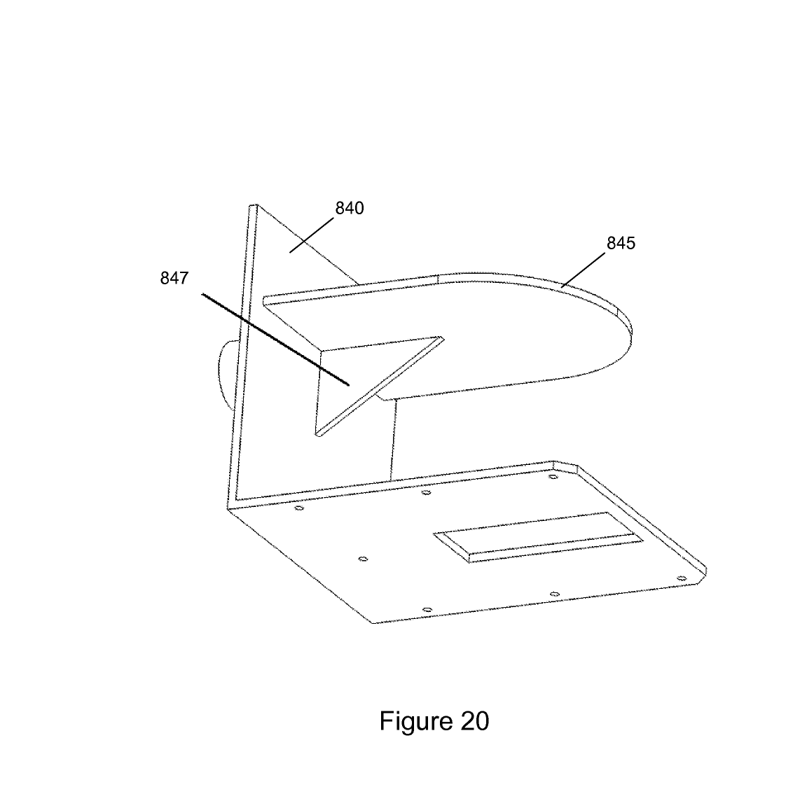

To prevent unrestricted self-rotation of the shaker plate 230, referring to FIGS. 18-20, a notch 850 is made at the edge of the shaker plate 230. Bearings 860 are mounted on the sides of the notch 850. The overhanging plate 845 is fixed to the frame 840 by the support of a rib plate 847. In operation, the rib plate 847 is clamped by bearings 860 to prevent a rotation but allow vibrations of the shaker plate 230 when it conducts circular movement around the center shaft 250.

In cooking operation, the cooking pan in the above disclosed cooking apparatus is moved together with the shaker plate and the upper frame. The food ingredients are moved and sometimes obstructed by the barriers in the cooking pan. The movements of the food ingredients in the cooking pan can include accelerations, vibrations, rotations, and/or translations. The inertia of the food ingredients cause them to flip, turn, jump, tumble, and/or to be thrown in the air in the cooking pan, which achieve the effects of stirring, mixing, and aeration of the food ingredients. The movements and the barriers are designed to add randomness to the movements and the obstruction to the movements of the food ingredients to achieve the most optimal stirring and mixing.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

Only a few examples and implementations are described. Other implementations, variations, modifications and enhancements to the described examples and implementations may be made without deviating from the spirit of the present invention. For example, the term cooking pan is used to generally refer to a device for containing food ingredients during cooking. Other words such as wok, cooking pot, cooking ware, etc. can also be used to describe the cooking device. The cooking is also not limited to any particular ethnic styles such as stir fry, and the cooking of Asian, Mexican, Middle Eastern, or European food. In addition, the barriers and cooking pan can be selected to best suit the types of food ingredients and style of cooking.

Furthermore, the movements of the cooking pan or cooking pan can have other configurations from the examples given above. For example, the radius of circular movements can vary depending on the types of food ingredients and style of cooking. Furthermore, the movements of any or all motors or mechanisms described above may be controlled by a programmed computer or controllers, according to the types of food.

1. An automated cooking apparatus, comprising:
a cooking pan comprising an internal surface and one or more barriers constructed on or near the internal surface, wherein the cooking pan is configured to hold food ingredients for cooking; and
a transport mechanism configured to move the cooking pan to produce movements in the food ingredients, wherein the one or more barriers are configured to obstruct the food ingredients' movements to produce stirring and mixing in the food ingredients.

2. The automated cooking apparatus of claim 1, wherein the transport mechanism comprises a pair of shaft and sleeve, wherein the one of the shaft or the sleeve is connected to the cooking pan, and wherein the other one of the shaft or the sleeve is configured to conduct a rotational movement.

3. The automated cooking apparatus of claim 1, wherein the transport mechanism is configured to produce a circular movement in the cooking pan while preserving orientation of the cooking pan.

4. The automated cooking apparatus of claim 3, wherein the transport mechanism is configured to allow a radius of the circular movement to be adjusted according to types of food ingredients and styles of the cooking.

5. The automated cooking apparatus of claim 1, wherein the transport mechanism configured to rotate the cooking pan.

6. The automated cooking apparatus of claim 1, wherein the transport mechanism is configured to move the cooking pan in a spherical motion.

7. The automated cooking apparatus of claim 1, wherein the one or more barriers has a cross-shape, a star-shape, a ring-shape, or a spiral-shape.

8. The automated cooking apparatus of claim 1, wherein the one or more barriers are constructed on the internal surface of the cooking pan.

9. The automated cooking apparatus of claim 1, wherein the one or more barriers are constructed above and near the internal surface of the cooking pan.

10. The automated cooking apparatus of claim 9, where a distance of the one or more barriers from the internal surface of the cooking pan is adjustable.

11. The automated cooking apparatus of claim 1, wherein the one or more barriers comprise rugged or textured surface structure on the internal surface of the cooking pan.

12. The automated cooking apparatus of claim 1, wherein the one or more barriers have the shape of a ridge, a wall, or a bump.

13. The automated cooking apparatus of claim 1, wherein the one or more barriers are configured to cause the food ingredients to turn, tumble, jump, flip and/or to be thrown in the air by obstructing to movements of the food ingredients.

14. The automated cooking apparatus of claim 1, wherein the transport mechanism is configured to produce a linear movement in the cooking pan or to move the cooking pan by combining two or more linear motions.

15. The automated cooking apparatus of claim 14, wherein the transport mechanism is configured to move the cooking pan in two intercepting linear directions.

16. The automated cooking apparatus of claim 1, wherein the transport mechanism is configured to produce accelerations, vibrations, rotations, and/or translations in the food ingredients in the cooking pan.

17. An automated cooking apparatus, comprising:
a cooking pan configured to hold food ingredients for cooking, wherein the cooking pan comprises an internal surface having a surface structure; and
a transport mechanism configured to move the cooking pan to produce movements in the food ingredients, wherein the surface structure is configured to obstruct the food ingredients' movements to produce stirring and mixing in the food ingredients.

18. The automated cooking apparatus of claim 17, wherein the surface structure comprises one or more barriers constructed on or near the internal surface.

19. The automated cooking apparatus of claim 17, wherein the surface structure comprises a ridge, a wall, a bump, or a rugged or textured surface.
